(19) United States
(12) Patent Application Publication
(10) Pub. No.: US 2021/0183097 A1
(43) Pub. Date: Jun. 17, 2021

(54) Spare Part Identification Using a Locally Learned 3D Landmark Database

(71) Applicant: Siemens Aktiengesellschaft, Munich (DE)

(72) Inventors: Georgios Georgakis, Manassas, VA (US); Srikrishna Karanam, Plainsboro, NJ (US); Ziyan Wu, Princeton, NJ (US); Jan Ernst, Princeton, NJ (US)

(21) Appl. No.: 16/760,616

(22) PCT Filed: Aug. 31, 2018
(86) PCT No.: PCT/US2018/049100

§ 371 Date: Apr. 30, 2020

Related U.S. Application Data
(60) Provisional application No. 62/585,042, filed on Nov. 13, 2017.

(51) Int. Cl. G06T 7/73; G06N 3/08

(52) U.S. Cl. CPC G06T 7/74; G06N 3/08; G06T 2207/20084; G06T 2207/10028; G06T 2207/20081

(57) ABSTRACT

Systems, methods, and computer-readable media are described for training a neural network to perform keypoint detection and view-invariant keypoint representation generation. A locally learned database of three-dimensional (3D) keypoint landmarks extracted from a sample set of training depth images can be populated with view-invariant keypoint representations of the keypoint landmarks stored in association with corresponding 3D locations of the keypoint landmarks. The populated 3D keypoint landmark database can be used to find 3D keypoints that match 2D keypoints extracted from a test depth image having an unknown pose. A parameter estimation algorithm can be executed on the 3D locations of the matching keypoint landmarks to determine a pose corresponding to the test depth image.

### CROSS-REFERENCE TO RELATED APPLICATION(S)

This application claims the benefit of U.S. Provisional Application No. 62/585,042 filed on Nov. 13, 2017, the content of which is incorporated by reference in its entirety herein.

### BACKGROUND

A physical assembly may include a large number of constituent parts. During operation, a part within the assembly may fail or otherwise require replacement due to normal wear and tear. For assemblies containing a large number of parts across a range of sizes, identifying a particular part for replacement through manual inspection may be cumbersome. Further, in certain instances, differentiating one part from another may be difficult.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic diagram illustrating training of a neural network to perform keypoint detection and view-invariant keypoint representation generation in accordance with one or more example embodiments of the disclosure.

FIG. 2 is a process flow diagram of an illustrative method for training a neural network to perform keypoint detection and view-invariant keypoint representation generation in accordance with one or more example embodiments of the disclosure.

FIG. 3 is a process flow diagram of an illustrative method for populating a locally learned three-dimensional (3D) keypoint landmark database using a trained neural network in accordance with one or more example embodiments of the disclosure.

FIG. 4 is a process flow diagram of an illustrative method for utilizing the populated 3D keypoint landmark database to determine a set of 3D locations corresponding to a set of keypoints extracted from an input depth image using the trained neural network and executing a parameter estimation algorithm on the set of 3D locations to determine a pose corresponding to the input depth image in accordance with one or more example embodiments of the disclosure.

FIG. 5 is a process flow diagram of an illustrative method for executing the parameter estimation algorithm in accordance with one or more example embodiments of the disclosure.

FIG. 6 is a schematic diagram of an illustrative networked architecture in accordance with one or more example embodiments of the disclosure.

### DETAILED DESCRIPTION

This disclosure relates to, among other things, devices, servers, systems, methods, computer-readable media, techniques, and methodologies for automated identification of parts of a parts assembly using depth data and a locally learned database of three-dimensional (3D) keypoint landmarks. The parts assembly may be any machine assembly containing constituent physical parts. For instance, as a non-limiting example, the parts assembly may be train vehicle composed of over one hundred thousand parts including thousands of unique spare parts.

The problem of part identification can be cast as a pose estimation problem. That is, once a pose of a camera/sensor that captures an image of a parts assembly is known, a label map of parts of the parts assembly can be rendered as an overlay over the captured image using a 3D simulated model (e.g., a 3D computer-aided design (CAD) model) of the parts assembly. The 3D CAD model may be represented in 3D space using an XYZ coordinate system. The 3D CAD model may be associated with metadata that may include an identification of the parts of the physical assembly (e.g., part numbers), an identification of the locations of parts within the assembly, and so forth.

As noted above, the part identification problem reduces to one of estimating the camera pose, and conventional approaches for part identification formulate the problem using concepts from image search. More specifically, in one such approach, depth images from multiple viewpoints of a 3D simulated model of a parts assembly (e.g., a 3D CAD model) are sampled and rendered. Each image is then represented in some high-dimensional feature space using a learned model, and a database of feature representations of the images, indexed by pose, is populated. Subsequently, given a query image at testing time, a nearest neighbor search is employed in the learned feature space, and the pose corresponding to the retrieved nearest neighbor is assigned to the query image. Once the pose is assigned to the query image, a label map of parts can be rendered over the query image. More specifically, the 3D CAD model of the parts assembly can be rendered over the query image from a virtual viewpoint representative of the assigned pose which, in turn, corresponds to an actual viewpoint from which the query image was taken. In this manner, the parts of the parts assembly represented by the rendered 3D CAD model may be aligned with parts of the parts assembly captured in the query image with respect to their relative orientations and locations within the assembly. The label map of parts can then be rendered over the query image based on the rendered 3D CAD model that is aligned with the query image.

In conventional approaches such as the one described above, a depth image of the 3D CAD model that is captured by one or more depth sensors often includes background noise and/or noise associated with the portion of the image that includes the object of interest (e.g., a parts assembly). As a result, employing the feature-based approach described above can result in an inaccurate feature representation of the depth image due to the noise, which in turn, can affect the accuracy of the downstream part identification.

Example embodiments address the technical problem of inaccurate feature representations derived from depth images that contain noise and the resulting inaccuracy of downstream part identification by providing a technical solution that includes performing, as part of a training phase, localized representation learning to build a database of 3D keypoint landmarks and local features. Then, during a testing phase, keypoints of a query image are computed, the closest matching points in the 3D keypoint landmark database for each keypoint are determined, and a parameter estimation algorithm is executed to estimate the pose of the query image.

Illustrative methods according to example embodiments of the invention will now be described. Each operation of any of the methods 200-500 may be performed by one or more components that may be implemented in any combination of hardware, software, and/or firmware. In certain example embodiments, one or more of these component(s) may be implemented, at least in part, as software and/or firmware that contains or is a collection of one or more program modules that include computer-executable instructions that when executed by a processing circuit cause one or more operations to be performed. A system or device described herein as being configured to implement example embodiments of the invention may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

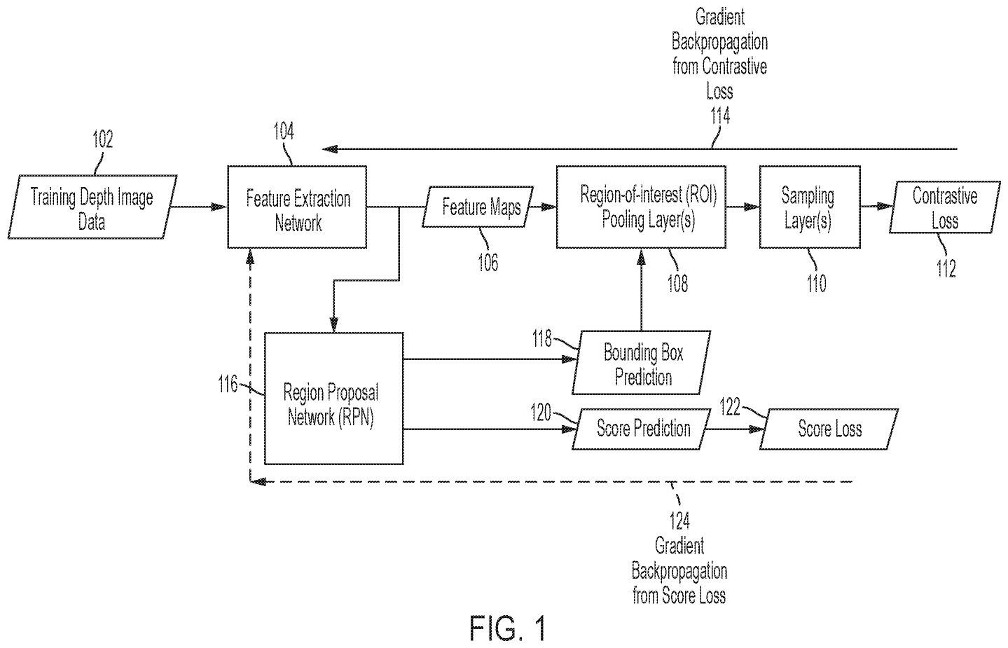

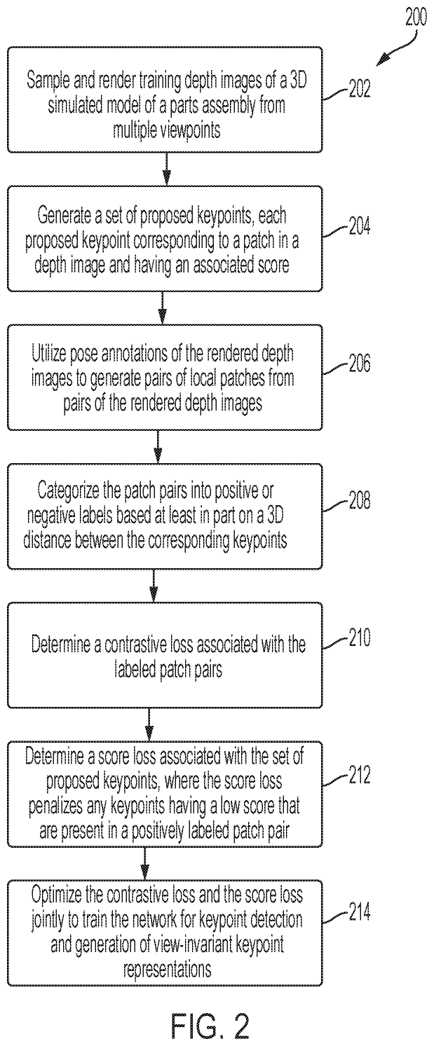

FIG. 1 is a schematic diagram illustrating training of a neural network to perform keypoint detection and view-invariant keypoint representation generation in accordance with one or more example embodiments of the disclosure. FIG. 2 is a process flow diagram of an illustrative method 200 for training a neural network to perform keypoint detection and view-invariant keypoint representation generation in accordance with one or more example embodiments of the disclosure. FIGS. 1 and 2 will be described in conjunction with one another hereinafter.

At block 202 of the method 200, in example embodiments, a set of images from multiple viewpoints (poses) are sampled and rendered from a simulated 3D model such as a 3D CAD model. The 3D CAD model may be representative, in example embodiments, of a parts assembly containing a plurality of constituent parts. The set of images sampled and rendered at block 202 may serve as training depth image data 102 that may be provided to a local feature representation machine learning algorithm in accordance with example embodiments.

In example embodiments, the local feature representation machine learning algorithm may be a Siamese convolutional neural network (CNN) that receives, as input, pairs of the training depth images 102, based on which, the Siamese CNN is trained to generate meaningful keypoints and learn keypoint representations jointly for the depth image pairs. Although example embodiments may be described herein in reference to a Siamese CNN, it should be appreciated that alternative machine learning constructs may be employed in example embodiments. Generally speaking, a keypoint may be a point of particular interest in an image. For example, in an image of a planar structure, the keypoints may include points along the edges of the structure as well as points corresponding to the corners of the planar structure. In example embodiments, a keypoint representation may be a feature representation such as a feature vector corresponding to a keypoint.

Referring now specifically to FIG. 1, in example embodiments, the Siamese CNN may include a base CNN (e.g., a VGG-based network architecture) that includes, without limitation, a feature extraction network 104, one or more region-of-interest (ROI) layers 108, and one or more sampling layers 110. The functionality of these various CNN components will be described in more detail later in this disclosure. The Siamese CNN may further include a region proposal network (RPN) 116 configured to generate keypoint proposals from the training depth images 102.

Referring again to FIG. 2, at block 204 of the method 200, the RPN 116 may generate a set of proposed keypoints from the training depth images 102. Each proposed keypoint may be contained within a local patch of a training depth image 102. In example embodiments, a patch be an N pixel×M pixel portion of a training depth image 102 (where N and M may be the same value or different values), and each proposed keypoint may be a center pixel of a corresponding local patch. In example embodiments, the RPN 116 may generate a respective score prediction 120 for each proposed keypoint. The score prediction 120 for a keypoint may be a metric indicative of a distinctiveness of the keypoint in a training depth image 102. More specifically, in example embodiments, each keypoint may include: i) a two-dimensional (2D) coordinate indicative of the location of the keypoint in a training depth image 102, ii) a 3D coordinate indicative of a physical location of the keypoint in a 3D coordinate system (as determined from a 3D simulated model such as a 3D CAD model), iii) a feature representation (e.g., a feature vector) corresponding to the keypoint, and iv) a prediction score 120 corresponding to the keypoint.

At block 206 of the method 200, pose annotations of the training depth images 102 may be used to generate pairs of local patches from the input pairs of training depth images 102. More specifically, in example embodiments, the feature extraction network 104 may generate feature maps 106 from the training depth images 102. The feature maps 106 may include feature representations corresponding to points in the training depth images 102. The feature maps 106 may be provided to the RPN 116 which may perform one or more convolution operations to generate the proposed keypoints from the feature maps 106: this includes generating the bounding box prediction 118 for each keypoint and its corresponding score prediction 120. The feature maps 106 may also be provided to the ROI pooling layer(s) 108, which additionally receive the predicted bounding boxes 118 generated by the RPN 116. The predicted bounding boxes 118 may be indicative of the size of local patches around proposed keypoints. In particular, the predicted bounding boxes 118 may indicate a pixel width and a pixel height of the local patch corresponding to each proposed keypoint. In example embodiments, the ROI layer(s) 108 and the sampling layer(s) 110 may generate local feature representations for the keypoints proposed by the RPN 116 as well as organize the keypoints (e.g., the patches that contain the keypoints) into local patch pairs.

At block 208 of the method 200, the Siamese CNN may categorize the local patch pairs into positive or negative labels based at least in part on a 3D distance between the proposed keypoints corresponding to the local patch pairs. More specifically, a 3D distance such as a Euclidean distance may be determined between the proposed keypoints of a local patch pair. In example embodiments, the 3D coordinates of the proposed keypoints may be determined from the 3D simulated model (e.g., the 3D CAD model). In example embodiments, if the determined Euclidean distance satisfies a threshold value (e.g. is less than, or in some embodiments, less than or equal to the threshold value), a positive label is assigned to the corresponding local patch pair, whereas if the determined Euclidean distance does not satisfy the threshold value (e.g., is greater than, or in some embodiments, greater than or equal to the threshold value), a negative label is assigned to the local patch pair. In this manner, a positive or negative label may be assigned to each local patch pair. In example embodiments, a positive label may be represented by a binary 1 and a negative label may be represented by a binary 0, or vice versa.

At block 210 of the method 200, a contrastive loss 112 may be determined with respect to the labeled patch pairs. The contrastive loss function 112 ensures that feature representations of keypoints (also referred to herein as keypoint representations) of local patch pairs that have been assigned a positive label are close in the feature space and that feature representations of keypoints of local patch pairs that have been assigned a negative label are relatively far in the feature space. The measure of distance between keypoint representations may be a Euclidean norm. At block 212 of the method 200, a score loss 122 associated with the proposed keypoints may be determined. In example embodiments, the score less may be a multinomial logistic loss defined as follows:

$$\frac{1}{N} {Σ}_{i}^{N} {y}_{i} log {y}_{i}^{′} + ( 1 - {y}_{i} ) , log ( 1 - {y}_{i}^{′} ) ,$$

where N represents the number of keypoints; i indexes over the keypoints; yᵢ′ represents the predicted score for the ith keypoint; and yᵢ represents the label assigned to the local patch pair to which the ith keypoint belongs.

In example embodiments, the above-described score loss function penalizes any proposed keypoints having a low predicted score 120 (e.g., a predicted score 120 below a threshold value) that correspond to a local patch pair that has been assigned a positive label. Referring to the specific multinomial logistic loss function presented above, the loss function seeks to push yᵢ′ as close to 1 as possible when yᵢ is a positive label and push yᵢ′ as close to 0 as possible when yᵢ is a negative label. In effect, the score loss function forces the Siamese CNN to produce high scores for keypoints in a local patch pair that are close to one another in the physical space.

It should be appreciated that the example score loss function presented above is merely illustrative and not exhaustive. For instance, in example embodiments, another monotonically increasing function can be used for the score loss function. As another non-limiting example, in certain example embodiments, a variation of the loss function described above can be employed. In particular, referring to the example loss function above, yᵢ log yᵢ′ is only non-zero and contributing to the score loss 122 when a local patch pair has been assigned a positive label and (1−y₁) log (1−yᵢ′) is only non-zero and contributing to the score loss 122 when a local patch pair has been assigned a negative label. Accordingly, in example embodiments, both operands are not contributing to the score loss 122 at the same time (e.g., for the same local patch pair). Thus, in example embodiments, only the first operand yᵢ log yᵢ′ corresponding to only the positively labeled local patch pairs may be used for the score loss function.

At block 214 of the method 200, the contrastive loss 112 and the score loss 122 may be optimized to train the Siamese CNN to perform keypoint detection and generation of view-invariant keypoint representations. More specifically, in example embodiments, errors in the contrastive loss 112 can be backpropagated 114 for each depth image pair to update parameters of the Siamese CNN until the contrastive loss 112 is optimized and the network is trained to generate view-invariant keypoint representations. A view-invariant keypoint representation may be a keypoint representation that corresponds to the same point in physical space regardless of the viewpoint of the image from which the keypoint is extracted. In addition, errors in the score loss 122 can be backpropagated 124 for each depth image pair to update parameters of the Siamese CNN until the score loss 122 is optimized and the network is trained to generate high scoring keypoints that correspond to the same physical location in physical space.

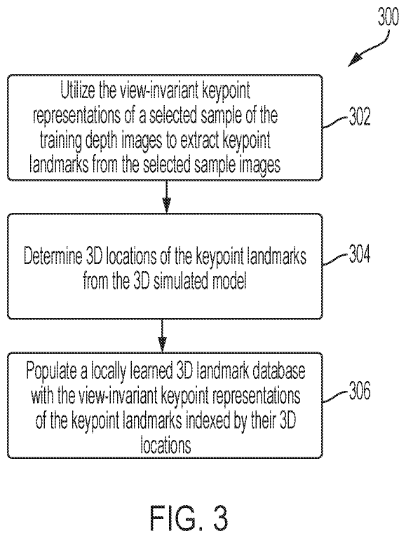

FIG. 3 is a process flow diagram of an illustrative method 300 for populating a locally learned 3D keypoint landmark database using a trained neural network such as a neural network trained in accordance with the illustrative method of FIG. 2. Once the network is trained, at block 302 of the method 300, view-invariant keypoint representations generated by the trained network for a selected sample of the training depth images 102 are used, in example embodiments, to extract keypoint landmarks from the selected sample images. Then, at block 304 of the method 300, 3D locations corresponding to the extracted keypoint landmarks are determined from the 3D simulated model. More specifically, in example embodiments, a 3D CAD model from which the input depth images 102 were generated may indicate the 3D locations of the extracted keypoint landmarks. At block 306 of the method 300, a locally learned 3D keypoint landmark database may be populated with the view-invariant keypoint representations of the keypoint landmarks indexed by their 3D locations. More specifically, the locally learned 3D keypoint landmark database may be populated with a set of tuples, where each tuple associates a view-invariant keypoint representation of a particular keypoint landmark with its corresponding 3D location.

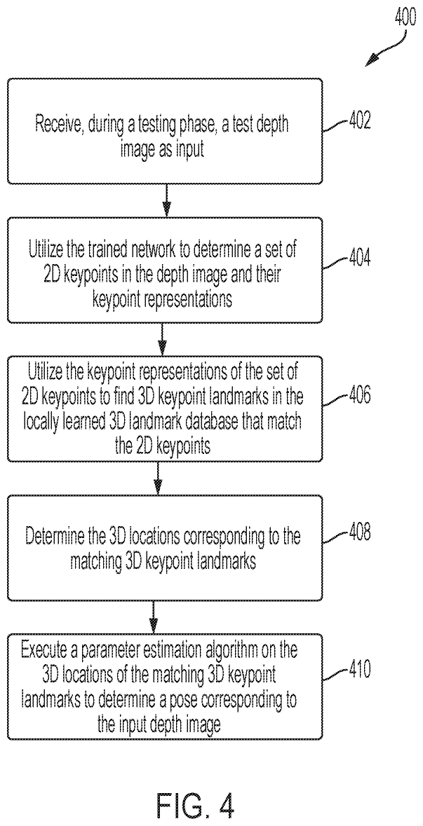

FIG. 4 is a process flow diagram of an illustrative method 400 for utilizing the populated 3D keypoint landmark database to determine a set of 3D locations corresponding to a set of keypoints extracted from an input depth image using the trained neural network and executing a parameter estimation algorithm on the set of 3D locations to determine a pose corresponding to the input depth image in accordance with one or more example embodiments of the disclosure. The illustrative method 400 may be performed subsequent to the training of the neural network embodied by the illustrative method 200 of FIG. 2 and subsequent to the populating of the 3D keypoint landmark database embodied by the illustrative method 300 of FIG. 3.

A block 402 of the method 400, the trained network may receive a test depth image as input as part of a testing phase. The input depth image may be generated by any of a variety of suitable depth sensors. The pose associated with the input test depth image (e.g., the viewpoint from which the input image is taken) may be unknown. At block 404 of the method 400, the trained network may be used to determine a set of 2D keypoints in the depth image and their keypoint representations. Then, at block 406 of the method 400, the keypoint representations corresponding to the set of 2D keypoints may be used to search the locally learned 3D keypoint landmark database to locate 3D keypoint landmarks in the database that match the 2D keypoints extracted from the input test depth image. At block 408 of the method 400, 3D locations corresponding to the matching keypoint landmarks may be determined.

More specifically, at blocks 406 and 408 of the method, stored view-invariant keypoint representations in the 3D keypoint landmark database (e.g., feature vectors) that match the keypoint representations (e.g., feature vectors) of the 2D keypoints extracted from the test input depth image may be located and the corresponding 3D locations stored in association with the matching view-invariant keypoint representations may be determined. A feature vector stored in the 3D keypoint landmark database that is determined to match a feature vector corresponding to a 2D keypoint extracted from the test input depth image may be a stored feature vector whose Euclidean distance to the feature vector corresponding to the 2D extracted keypoint is smallest among all stored feature vectors. In example embodiments, the matching process yields a set of one-to-one correspondences between the 2D keypoints extracted from the test input depth image and 3D keypoint landmarks stored in the database. In certain example embodiments, in order to compensate for any misalignment between the matched 3D keypoint landmarks and the corresponding 2D extracted keypoints, patches around each 2D keypoint can be sampled, and the keypoint in a sampled patch that has the smallest Euclidean distance in the feature space to the corresponding matched 3D keypoint landmark can be selected as an updated 2D keypoint.

Finally, at block 410 of the method 400, a parameter estimation algorithm may be executed on the 3D locations of the matching 3D keypoint landmarks to determine a pose corresponding to the input depth image. In example embodiments, the parameter estimation algorithm may parameterize a camera pose using 9 parameters-3 translation parameters and 6 rotation parameters. Generally speaking, the parameter estimation algorithm seeks to estimate a camera pose corresponding to the input test depth image based on a subset of the one-to-one correspondences between the 2D keypoints extracted from the test input depth image and 3D keypoint landmarks stored in the database, and subsequently determine how accurate the estimated pose is with respect to the one-to-one correspondences outside of the subset.

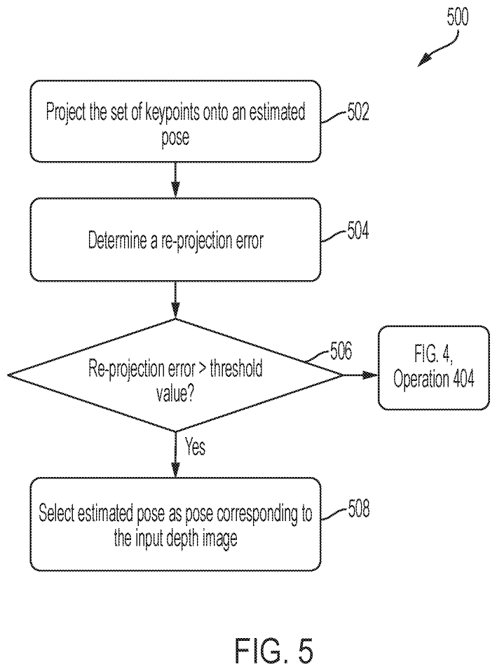

FIG. 5 is a process flow diagram of an illustrative method 500 for executing the parameter estimation algorithm in accordance with one or more example embodiments of the disclosure. At block 502 of the method 500, the set of keypoints may be projected according to an estimated camera pose determined during a particular iteration of the parameter estimation algorithm. At block 504 of the method 500, a re-projection error may be determined based at least in part on the projection of the set of keypoints according to the estimated camera pose. The re-projection error may be a measure of the Euclidean distances between the set of keypoints extracted from the test input depth image and their corresponding matching 3D points selected from the locally learned 3D keypoint landmark database. At block 506 of the method 500, a determination may be made as to whether the re-projection error is less than a threshold value.

In response to a positive determination at block 506, the estimated pose may be selected as the camera pose corresponding to the test input depth image. On the other hand, in response to a negative determination at block 506, the method 500 may proceed iteratively from block 404 of the method 400, where a new set of 2D keypoints may be extracted from the test input depth image. The parameter estimation algorithm may be iteratively executed in this manner until the algorithm converges to a set of 2D keypoints that yield a pose estimation that results in a re-projection error that is less than the threshold value. Once an acceptable camera pose is identified, an image of the 3D CAD model from a virtual viewpoint corresponding to the camera pose can be rendered as an overlay over the input test depth image. A parts map can then be rendered as an overlay to facilitate part identification.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

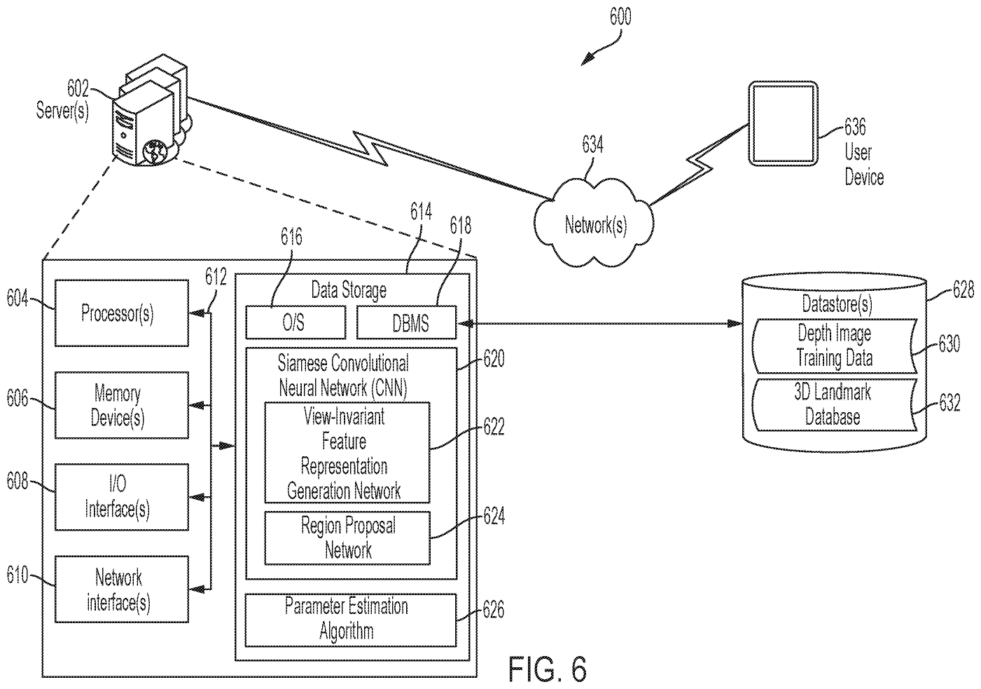

FIG. 6 is a schematic diagram of an illustrative networked architecture 600 in accordance with one or more example embodiments of the disclosure. The networked architecture 600 may include one or more user devices 636 and one or more back-end servers 602. While multiple user devices 636 and/or multiple servers 602 may form part of the networked architecture 600, these components will be described in the singular hereinafter for ease of explanation. In certain example embodiments, the server 602 may be configured to execute any of the illustrative methods 200-500. Further, in example embodiments, the user device 636 may be configured to capture depth images of objects of interest (e.g., a parts assembly). As such, the user device 636 may include one or more depth sensors for capturing depth images. However, it should be appreciated that any functionality described in connection with the server 602 may be distributed among multiple servers 602. Similarly, any functionality described in connection with the user device 636 may be distributed among multiple user devices 636 and/or between a user device 636 and one or more servers 602.

The server(s) 602 and the user device(s) 636 may be configured to communicate via one or more networks 634 which may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 634 may have any suitable communication range associated therewith and may include, for example, global networks (e.g., the Internet), metropolitan area networks (MANS), wide area networks (WANs), local area networks (LANs), or personal area networks (PANs). In addition, the network(s) 634 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the server 602 may include one or more processors (processor(s)) 604, one or more memory devices 606 (generically referred to herein as memory 606), one or more input/output (“I/O”) interface(s) 608, one or more network interfaces 610, and data storage 614. The server 602 may further include one or more buses 612 that functionally couple various components of the server 602. These various components will be described in more detail hereinafter.

The bus(es) 612 may include at least one of a system bus, a memory bus, an address bus, or a message bus, and may permit exchange of information (e.g., data (including computer-executable code), signaling, etc.) between various components of the server 602. The bus(es) 612 may include, without limitation, a memory bus or a memory controller, a peripheral bus, an accelerated graphics port, and so forth. The bus(es) 612 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 606 of the server 602 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 606 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 606 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 614 may include removable storage and/or non-removable storage including, but not limited to, magnetic storage, optical disk storage, and/or tape storage. The data storage 614 may provide non-volatile storage of computer-executable instructions and other data. The memory 606 and the data storage 614, removable and/or non-removable, are examples of computer-readable storage media (CRSM) as that term is used herein.

The data storage 614 may store computer-executable code, instructions, or the like that may be loadable into the memory 606 and executable by the processor(s) 604 to cause the processor(s) 604 to perform or initiate various operations. The data storage 614 may additionally store data that may be copied to memory 606 for use by the processor(s) 604 during the execution of the computer-executable instructions. Moreover, output data generated as a result of execution of the computer-executable instructions by the processor(s) 604 may be stored initially in memory 606, and may ultimately be copied to data storage 614 for non-volatile storage.

More specifically, the data storage 614 may store one or more operating systems (O/S) 616; one or more database management systems (DBMS) 618; and one or more program modules, applications, engines, computer-executable code, scripts, or the like such as, for example, a Siamese CNN 620 (which in turn may include a view-invariant feature representation generation network 622 and an RPN 624) and a parameter estimation algorithm 626. Any of the components depicted as being stored in data storage 614 may include any combination of software, firmware, and/or hardware. The software and/or firmware may include computer-executable code, instructions, or the like that may be loaded into the memory 606 for execution by one or more of the processor(s) 604 to perform any of the operations described earlier in connection with correspondingly named modules.

The data storage 614 may further store various types of data utilized by components of the server 602 such as, for example, any of the data depicted as being stored in the datastore(s) 528. Any data stored in the data storage 614 may be loaded into the memory 606 for use by the processor(s) 604 in executing computer-executable code. In addition, any data stored in the datastore(s) 528 may be accessed via the DBMS 618 and loaded in the memory 606 for use by the processor(s) 604 in executing computer-executable code.

The processor(s) 604 may be configured to access the memory 606 and execute computer-executable instructions loaded therein. For example, the processor(s) 604 may be configured to execute computer-executable instructions of the various program modules, applications, engines, or the like of the server 602 to cause or facilitate various operations to be performed in accordance with one or more embodiments of the disclosure. The processor(s) 604 may include any suitable processing unit capable of accepting data as input, processing the input data in accordance with stored computer-executable instructions, and generating output data. The processor(s) 604 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 604 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 604 may be capable of supporting any of a variety of instruction sets.

Referring now to other illustrative components depicted as being stored in the data storage 614, the O/S 616 may be loaded from the data storage 614 into the memory 606 and may provide an interface between other application software executing on the server 602 and hardware resources of the server 602. More specifically, the O/S 616 may include a set of computer-executable instructions for managing hardware resources of the server 602 and for providing common services to other application programs (e.g., managing memory allocation among various application programs). In certain example embodiments, the O/S 616 may control execution of one or more of the program modules depicted as being stored in the data storage 614. The O/S 616 may include any operating system now known or which may be developed in the future including, but not limited to, any server operating system, any mainframe operating system, or any other proprietary or non-proprietary operating system.

The DBMS 618 may be loaded into the memory 606 and may support functionality for accessing, retrieving, storing, and/or manipulating data stored in the memory 606 and/or data stored in the data storage 614. The DBMS 618 may use any of a variety of database models (e.g., relational model, object model, etc.) and may support any of a variety of query languages. The DBMS 618 may access data represented in one or more data schemas and stored in any suitable data repository.

The datastore(s) 628 may include, but are not limited to, databases (e.g., relational, object-oriented, etc.), file systems, flat files, distributed datastores in which data is stored on more than one node of a computer network, peer-to-peer network datastores, or the like. The datastore(s) 628 may store various types of data such as, for example, depth image data 630 (e.g., the depth image data 102), the 3D keypoint landmark database 632; and so forth.

Referring now to other illustrative components of the server 602, the input/output (I/O) interface(s) 608 may facilitate the receipt of input information by the server 602 from one or more I/O devices as well as the output of information from the server 602 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the server 602 or may be separate. The I/O devices may further include, for example, any number of peripheral devices such as data storage devices, printing devices, and so forth.

The I/O interface(s) 608 may also include an interface for an external peripheral device connection such as universal serial bus (USB), FireWire, Thunderbolt, Ethernet port or other connection protocol that may connect to one or more networks. The I/O interface(s) 608 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The server 602 may further include one or more network interfaces 610 via which the server 602 may communicate with any of a variety of other systems, platforms, networks, devices, and so forth. The network interface(s) 610 may enable communication, for example, between the server 602 and the user device 636 via the network(s) 634.

It should be appreciated that the program modules, applications, computer-executable instructions, code, or the like depicted in FIG. 6 as being stored in the data storage 614 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the server 602, the user device 636, and/or hosted on other computing device(s) accessible via one or more of the network(s) 634, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the server 602 may include alternate and/or additional hardware, software, or firmware components beyond those described or depicted without departing from the scope of the disclosure. More particularly, it should be appreciated that software, firmware, or hardware components depicted as forming part of the server 602 are merely illustrative and that some components may not be present or additional components may be provided in various embodiments. While various illustrative program modules have been depicted and described as software modules stored in data storage 614, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

One or more operations of any of the methods 200-500 may be performed by a server 602, by a user device 636, or in a distributed fashion by a server 602 and a user device 636, or more specifically, by one or more engines, program modules, applications, or the like executable on such device(s). It should be appreciated, however, that such operations may be implemented in connection with numerous other device configurations.

The operations described and depicted in the illustrative methods of FIGS. 2-5 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2-5 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

That which is claimed is:

1. A computer-implemented method for determining a pose corresponding to an input depth image, the method comprising:
training, using a set of training depth images, a neural network to obtain a trained neural network configured to perform keypoint detection;
determining, utilizing the trained neural network, a set of view-invariant keypoint representations for a selected sample of the set of training depth images;
extracting a set of keypoint landmarks from the selected sample of the set of training depth images that correspond to the set of view-invariant keypoint representations;
populating a database with the set of view-invariant keypoint representations, wherein each view-invariant keypoint representation is stored in association with a three-dimensional (3D) location of a respective keypoint landmark corresponding to the view-invariant keypoint representation; and
utilizing the populated database to determine the pose corresponding to the input depth image.

2. The computer-implemented method of claim 1, wherein utilizing the populated database to determine to the pose corresponding to the input depth image comprises:
receiving the input depth image as input to the trained neural network;
determining, utilizing the trained neural network, a set of two-dimensional (2D) keypoints in the input depth image and a set of keypoint representations corresponding to the set of 2D keypoints;
determining a subset of the set of view-invariant keypoint representations in the populated database that match the set of keypoint representations corresponding to the set of 2D keypoints;
determining a set of 3D locations stored in association with the subset of view-invariant keypoint representations; and
executing a parameter estimation algorithm on the set of 3D locations to determine the pose corresponding to the input depth image.

3. The computer-implemented method of claim 2, wherein executing the parameter estimation algorithm comprises:
determining an estimated pose for the input depth image using the set of 3D locations;
projecting the set of 2D keypoints according to the estimated pose;
determining a re-projection error;
determining that the re-projection error satisfies a threshold value; and
selecting the estimated pose as the pose for the input depth image.

4. The computer-implemented method of claim 2, wherein the set of 2D keypoints is a first set of 2D keypoints, the set of keypoint representations is a first set of keypoint representations, the subset of view-invariant keypoint representations is a first subset of view-invariant keypoint representations, and the set of 3D locations is a first set of 3D locations, and wherein executing the parameter estimation algorithm comprises:
determining an estimated pose for the input depth image using the set of 3D locations;
projecting the set of 2D keypoints according to the estimated pose;
determining a re-projection error;
determining that the re-projection error does not satisfy a threshold value;
determining, utilizing the trained neural network, a second set of 2D keypoints in the input depth image and a second set of keypoint representations corresponding to the second set of 2D keypoints;
determining a second subset of the set of view-invariant keypoint representations in the populated database that match the second set of keypoint representations corresponding to the second set of 2D keypoints;
determining a second set of 3D locations stored in association with the second subset of view-invariant keypoint representations; and
executing the parameter estimation algorithm on the second set of 3D locations to determine the pose corresponding to the input depth image.

5. The computer-implemented method of claim 1, wherein training the neural network comprises:
generating, from a pair of the training depth images, a pair of local patches comprising a first local patch and a second local patch, wherein the first local patch contains a first keypoint and the second local patch contains a second keypoint;
determining a first keypoint score for the first keypoint and a second keypoint score for the second keypoint;
determining a 3D distance between the first keypoint and the second keypoint;
labeling, based at least in part on the 3D distance, the pair of local patches with a positive label or a negative label to obtain a label patch pair;
optimizing a contrastive loss based at least in part on the labeled patch pair;
optimizing a score loss based at least in part on the labeled patch pair, the first keypoint score, and the second keypoint score.

6. The computer-implemented method of claim 5, wherein optimizing the score loss comprises:
determining that the labeled patch pair is labeled with a positive label;
determining that the first keypoint score is less than a threshold value; and
penalizing the first keypoint.

7. The computer-implemented method of claim 5, wherein the score loss is a multinomial logistic loss defined as
$$\frac{1}{N} {Σ}_{i}^{N} {y}_{i} log {y}_{i}^{′} + ( 1 - {y}_{i} ) , log ( 1 - {y}_{i}^{′} ) .$$

8. A system for determining a pose corresponding to an input depth image, the system comprising:
at least one memory storing computer-executable instructions; and
at least one processor configured to access the at least one memory and execute the computer-executable instructions to:
train, using a set of training depth images, a neural network to obtain a trained neural network configured to perform keypoint detection;
determine, utilizing the trained neural network, a set of view-invariant keypoint representations for a selected sample of the set of training depth images;
extract a set of keypoint landmarks from the selected sample of the set of training depth images that correspond to the set of view-invariant keypoint representations;
populate a database with the set of view-invariant keypoint representations, wherein each view-invariant keypoint representation is stored in association with a three-dimensional (3D) location of a respective keypoint landmark corresponding to the view-invariant keypoint representation; and
utilize the populated database to determine the pose corresponding to the input depth image.

9. The system of claim 8, wherein the at least one processor is configured to utilize the populated database to determine to the pose corresponding to the input depth image by executing the computer-executable instructions to:
receive the input depth image as input to the trained neural network;
determine, utilizing the trained neural network, a set of two-dimensional (2D) keypoints in the input depth image and a set of keypoint representations corresponding to the set of 2D keypoints;
determine a subset of the set of view-invariant keypoint representations in the populated database that match the set of keypoint representations corresponding to the set of 2D keypoints;
determine a set of 3D locations stored in association with the subset of view-invariant keypoint representations; and
execute a parameter estimation algorithm on the set of 3D locations to determine the pose corresponding to the input depth image.

10. The system of claim 9, wherein the at least one processor is configured to execute the parameter estimation algorithm by executing the computer-executable instructions to:
determine an estimated pose for the input depth image using the set of 3D locations;
project the set of 2D keypoints according to the estimated pose;
determine a re-projection error;
determine that the re-projection error satisfies a threshold value; and
select the estimated pose as the pose for the input depth image.

11. The system of claim 9, wherein the set of 2D keypoints is a first set of 2D keypoints, the set of keypoint representations is a first set of keypoint representations, the subset of view-invariant keypoint representations is a first subset of view-invariant keypoint representations, and the set of 3D locations is a first set of 3D locations, and wherein the at least one processor is configured to execute the parameter estimation algorithm by executing the computer-executable instructions to:
determine an estimated pose for the input depth image using the set of 3D locations;
project the set of 2D keypoints according to the estimated pose;
determine a re-projection error;
determine that the re-projection error does not satisfy a threshold value;
determining, utilizing the trained neural network, a second set of 2D keypoints in the input depth image and a second set of keypoint representations corresponding to the second set of 2D keypoints;
determining a second subset of the set of view-invariant keypoint representations in the populated database that match the second set of keypoint representations corresponding to the second set of 2D keypoints;
determining a second set of 3D locations stored in association with the second subset of view-invariant keypoint representations; and
executing the parameter estimation algorithm on the second set of 3D locations to determine the pose corresponding to the input depth image.

12. The system of claim 8, wherein the at least one processor is configured to train the neural network by executing the computer-executable instructions to:
generate, from a pair of the training depth images, a pair of local patches comprising a first local patch and a second local patch, wherein the first local patch contains a first keypoint and the second local patch contains a second keypoint;
determine a first keypoint score for the first keypoint and a second keypoint score for the second keypoint;
determine a 3D distance between the first keypoint and the second keypoint;
label, based at least in part on the 3D distance, the pair of local patches with a positive label or a negative label to obtain a label patch pair;
optimize a contrastive loss based at least in part on the labeled patch pair;
optimize a score loss based at least in part on the labeled patch pair, the first keypoint score, and the second keypoint score.

13. The system of claim 12, wherein the at least one processor is configured to optimize the score loss by executing the computer-executable instructions to:
determine that the labeled patch pair is labeled with a positive label;
determine that the first keypoint score is less than a threshold value; and
penalize the first keypoint.

14. The system of claim 12, wherein the score loss is a multinomial logistic loss defined as
$$\frac{1}{N} {Σ}_{i}^{N} {y}_{i} log {y}_{i}^{′} + ( 1 - {y}_{i} ) , log ( 1 - {y}_{i}^{′} ) .$$

15. A computer program product for determining a pose corresponding to an input depth image, the computer program product comprising a storage medium readable by a processing circuit, the storage medium storing instructions executable by the processing circuit to cause a method to be performed, the method comprising:
training, using a set of training depth images, a neural network to obtain a trained neural network configured to perform keypoint detection;
determining, utilizing the trained neural network, a set of view-invariant keypoint representations for a selected sample of the set of training depth images;
extracting a set of keypoint landmarks from the selected sample of the set of training depth images that correspond to the set of view-invariant keypoint representations;
populating a database with the set of view-invariant keypoint representations, wherein each view-invariant keypoint representation is stored in association with a three-dimensional (3D) location of a respective keypoint landmark corresponding to the view-invariant keypoint representation; and
utilizing the populated database to determine the pose corresponding to the input depth image.

16. The computer program product of claim 15, wherein utilizing the populated database to determine to the pose corresponding to the input depth image comprises:
receiving the input depth image as input to the trained neural network;
determining, utilizing the trained neural network, a set of two-dimensional (2D) keypoints in the input depth image and a set of keypoint representations corresponding to the set of 2D keypoints;
determining a subset of the set of view-invariant keypoint representations in the populated database that match the set of keypoint representations corresponding to the set of 2D keypoints;
determining a set of 3D locations stored in association with the subset of view-invariant keypoint representations; and
executing a parameter estimation algorithm on the set of 3D locations to determine the pose corresponding to the input depth image.

17. The computer program product of claim 16, wherein executing the parameter estimation algorithm comprises:
determining an estimated pose for the input depth image using the set of 3D locations;
projecting the set of 2D keypoints according to the estimated pose;
determining a re-projection error;
determining that the re-projection error satisfies a threshold value; and
selecting the estimated pose as the pose for the input depth image.

18. The computer program product of claim 16, wherein the set of 2D keypoints is a first set of 2D keypoints, the set of keypoint representations is a first set of keypoint representations, the subset of view-invariant keypoint representations is a first subset of view-invariant keypoint representations, and the set of 3D locations is a first set of 3D locations, and wherein executing the parameter estimation algorithm comprises:
determining an estimated pose for the input depth image using the set of 3D locations;
projecting the set of 2D keypoints according to the estimated pose;
determining a re-projection error;
determining that the re-projection error does not satisfy a threshold value;
determining, utilizing the trained neural network, a second set of 2D keypoints in the input depth image and a second set of keypoint representations corresponding to the second set of 2D keypoints;
determining a second subset of the set of view-invariant keypoint representations in the populated database that match the second set of keypoint representations corresponding to the second set of 2D keypoints;
determining a second set of 3D locations stored in association with the second subset of view-invariant keypoint representations; and
executing the parameter estimation algorithm on the second set of 3D locations to determine the pose corresponding to the input depth image.

19. The computer program product of claim 15, wherein training the neural network comprises:
generating, from a pair of the training depth images, a pair of local patches comprising a first local patch and a second local patch, wherein the first local patch contains a first keypoint and the second local patch contains a second keypoint;
determining a first keypoint score for the first keypoint and a second keypoint score for the second keypoint;
determining a 3D distance between the first keypoint and the second keypoint;
labeling, based at least in part on the 3D distance, the pair of local patches with a positive label or a negative label to obtain a label patch pair;
optimizing a contrastive loss based at least in part on the labeled patch pair;
optimizing a score loss based at least in part on the labeled patch pair, the first keypoint score, and the second keypoint score.

20. The computer program product of claim 19, wherein optimizing the score loss comprises:
determining that the labeled patch pair is labeled with a positive label;
determining that the first keypoint score is less than a threshold value; and
penalizing the first keypoint.
